(19) United States
(12) Patent Application Publication
(10) Pub. No.: US 2018/0195337 A1
(43) Pub. Date: Jul. 12, 2018

(54) Frames, wings and pillars of wood for heat-insulating windows for passive buildings

(71) Applicant: Przedsiebiorstwo Produkcyjno-Handlowo-Uslugowe O.C, Bydgoszcz (PL)

(72) Inventor: Andrzej Ilnicki, Bydgoszcz (PL)

(21) Appl. No.: 15/917,396

(22) Filed: Mar. 9, 2018

(51) Int. Cl. E06B 3/30; E06B 3/58; E06B 3/70; E06B 3/263; E06B 3/44

(52) U.S. Cl. CPC E06B 3/303; E06B 3/5814; E06B 2003/4446; E06B 3/26345; E06B 3/44; E06B 3/7003

(57) ABSTRACT

Construction of frames, wings and posts of wood for insulating windows for passive construction are described. The wing uses six elements in the form of a rectangular wooden boards that are interconnected in such a way that the wood grain of the respective connected elements are matched alternately.

### FIELD OF INVENTION

The subject of the solution is structure of frame, wings and pillars of wood suitable for the construction of insulating windows for passive buildings.

### BACKGROUND OF INVENTION

Patent GB 181,284 is known a composite heat-insulating shaped profile intended, in particular for windows, doors, facades or the like. It consists of external and internal metal moldings (3, 4) interconnected and held in mutual spacing by means of at least one connecting means provided with cutters (5), insulating ribs (6). Connection moldings (5) enter the grooves secure the metal moldings (3, 4). Insulating rib (6) has two, substantially parallel, containing between them a cavity, delimiting walls (6.1, 6.2). Delimiting walls (6.1, 6.2) can be connected to each other by means of at least one rib section. Based on the wall thickness s=0.5 mm and a thermal conductivity lambda=0.35 W/mK limiting walls (6.1, 6.2) adopted for achieving the heat transfer resistance by the rib insulating the range between 0.15 m 2 K/W and 0 30 m 2 K/W the width (D) of the insulating rib of 20 mm in the range between 0.25 m 2 K/W and 0.50 m 2 K/W the width (D) of the rib of the insulating equal to 30 mm, in the range between 0.35 m 2 K/W and 0.65 m2K/W the width (D) of the insulating rib of 40 mm, and in the range between 0.40 m 2 K/W and 0.80 m 2 K/W the width (D) of the insulating rib of 50 mm. The width (d) of the hollow space or the hollow chamber is less than or equal to the width (D) of the rib of the insulation and greater than or equal to one third of the width (D) of the rib of the insulation, where the height of the cavity or the hollow chamber (11) is less than or equal to 5 mm. At the height of the cavity or the hollow chamber of 5 to 20 mm and at least one transverse rib, the existing ratio of the height (h) to width (d) is greater than or equal to 0.2 and less than or equal to 5. If the thickness (s) of the wall varies in the range between 0.25 mm and 1.0 mm, it must be taken into account dependence of the resistance of heat transfer than the thickness (s) of the wall according to the equation R (s)=R (s=0.25 mm)+(s-0.25)/0.25*delta R, and with the delta value R of 0.025 to 0.05. Increasing the thermal conductivity of the walls limiting (6.1, 6.2) by 10% in the range between 0.15 W/mK and 0.40 W/mK leads to a reduction in the heat transfer resistance by 2 to 4%, which should be taken into account when selected first of all sizes output.

From the description of the model EN 67359 is well known profile frames or wing door in heat system. Profile has a outer section (1) and inner section (2), which are combined together with thermal divider (3). Sections (1, 2) from the outer side portion (6) leading from a recess (7). The ratio of the width (4) of the chamber (5) minus the width (10) of the recess (7) and the thickness (11) of adjoining the wall (8) to the width (4) of the chamber (5) is from 0.25 to 0.53. Chambers of the outer profile (1) inner profile (2) are with respect to each of the internal constitute a mirror image with respect to the profile axis (12).

From the description of the utility model PL 58 799 is known a window of the post profile, which according to the utility model has the walls constituting the double-sided extension of the side fittings disposed on the outer side of the building, the rib. Forming an inner side of the post and parallel to its side of the second fitting they have bilateral extension as angular hooks, whose free ends are pointed straight ribs. The perpendicular sides of the fitting, which is part of the post from inside the building is angled hook, while on the inner surfaces of these sides are projections in the form of partial rings. The same projection on the inner surface of the side of the oblique projections on the other molding. On the inner surface of the side, which is part of the post on the inner side of the building, the bead. The two axis of symmetry lying opposite each other projections, in the form of partial rings are grooves.

It is known from the protective utility model EN 58800 profile of the door leaf which, in accordance with the utility model to the wall forming bilateral extension of the side fittings disposed to the outside of the building, and are bent inward end in the form of the letter “L”, and the inner surface of T-shaped rib. One of the walls has a protrusion, opposite there is a free end of the angular hook, which is an extension of the parallel side. The side moldings forming the frame member towards the inside of the building has an extension in the form of an angular hook which is opposite the angular detent disposed on the perpendicular side. On the side opposite to the side with the angled catch is a shelf.

It is known from the protective utility model EN 59030 profile of the window frame, which according to the utility model has body constituting an outer window frame, and has an extension side with sloping projections in the form of an angular hook, and the wall forming an extension of the outer side of the fitting, it has a folded end in the form of the letter “L”, and is provided on the inner surface of the T-shaped rib and simple appearance. The perpendicular side which is on the opposite side of the wall is trapezoidal shelf. The wall forming the extension side of the second fitting has arched end and a folded-inside the tip, and besides, the inner surface has a T-shaped rib. The vertical side has an angular hook and off, whose extension in the direction of and opposite the angle of the tap is the tongue. The opposite side has a groove with shelves arranged on the side walls of the groove.

It is known from the protective utility model EN 58802 frame profile, which is made up of two profiles connected by spacers, and is characterized in that the extensions of the sides are angled hooks, while their inner surfaces are trapezoidal projections. The side has a shelf and the wall extending away from the side, has an end bent in the form of the letter “L” and a T-shaped rib.

It is known from the protective utility model EN 59299 profile support post constituting a set of closed rectangular one chamber of the metal profile, and a closed rectangular two-chamber metal profile combined with one another geometrically and inherently by spacers thermal-metallic planar insert embedded in slots formed on the lateral outer opposite walls of the closed rectangular single-chamber metal Profile and closed two-chamber metal rectangular profile.

It is known from utility model application EN 109 282 composite profile window wings, which is composed of the outer element and the inner element connected to “dovetail” combining thermal insulation inserts. The main chamber of the outer element is made in the shape of the letter “L”. At the center partition is formed of a horizontal cavity reaching the bottom of the vertical walls, which projections are formed. Boom upper inner member passes on top of the beam to form a heat-insulating cavity.

Profile of a composite characterized in that the main chamber is made of rib divisionaly stiffening, while guide the outer rail retainer has an outer wall extending in a bottom wall at an angle of 40° to 50° combined with “bald spot” inclined at an angle of 8° to 12°. At the inner surface of the inner member is made of an additional barrier-forming chamber.

It is disclosed in the patent application P. 386872 profile frames or wing door heat or cold system. Profile of a front face profile of a thickened relative to the outer bearing wall profile.

It is disclosed in the patent application P. 386873 profile frames or wing door heat system. Profile has a external section and internal section, which are connected to one another thermal. Sections on the outer side of the head part with a recess. The width of the chamber less the width is selected and the thickness adjacent to the wall to the width of the chamber is from 0.25 to 0.53. Chambers of the profile of the internal and external section bar are a mirror image relative to each other with respect to the profile axis.

Is disclosed in the patent application P. 387026 leaf profile doors in the heat system especially for fixing the hinges rebate. Profile of the door leaf has a external section and internal section, which are connected to one another thermal. On the front it has two projections, and from the opposite side a receiver for fastening the glazing bead, the seat is completed projections. The ratio of the distance between the projections slot into the slot at a height of the projection is greater than 2.5, and the ratio of the width of the system's profile to the distance between the projections of the socket comprises from 3.7 to 6.0. In contrast, the distance between the splines to the width of the profile system is from 0.2 to 0.9.

### SUMMARY OF THE INVENTION

There are not known similar structures of frames, sashes and pillars of wood for heat-insulating windows for passive house, because only recently emerged thermal insulation glass packages with high thickness exceeding 100 mm. In the implementation phase inputs are packages of glass with a total thickness min. 100 mm. These packages have a very low heat transfer coefficient, which allows their use in passive construction.

The present design is a part of the wall, from floor to ceiling with the possibility of moving one or two segments in order to allow the exit, for example terrace, balcony and others. The windows made in this technology is characterized by low heat transfer coefficient and are intended for so-called. passive construction and their design allows for the opening and sealing, as well as ensures the stability of the structure.

### BRIEF DESCRIPTION OF THE DRAWINGS

The invention together with the above and other objects and advantages will be best understood from the following detailed description of the preferred embodiment of the invention shown in the accompanying drawings, wherein:

FIG. 1 depicts a cross-section view of a wing of an embodiment of the invention, in accordance with features of the present invention;

FIG. 2 depicts a cross-section view of a wing of another embodiment of the invention, in accordance with features of the present invention;

FIG. 3 depicts a cross-section view of bars of an embodiment of the invention, in accordance with features of the present invention;

FIG. 4 depicts a cross-section view of bars of another embodiment of the invention, in accordance with features of the present invention; and

FIG. 5 depicts a cross-section view of a frame of an embodiment of the invention, in accordance with features of the present invention.

The essence of this solution is to design a package of glass with a total thickness ≥100 mm and a very low coefficient of heat transfer in the frame side bars in order to obtain the final product in the form of windows and doors thermal insulation, preferably in the form of a window-sliding doors.

The wing of the invention consists of six elements in the form of a wooden rectangular boards which are interconnected preferably by means of an adhesive, wherein the components are glued in such a way that the wood grain of the respective connected elements are adjusted alternately to provide structural rigidity and eliminating the possibility of warping, the far-board is in the upper part of the profile projecting above the other components, forming the plane of the glass package, and symmetrically on the other hand is located glazing bead, protecting the glass against falling out. Glazing bead and fused glass package and are sealed with silicone. The central board centrally in the middle on the lower part with a recess whose side walls to the top and bottom sections are interconnected comp vertical section located at an acute angle, while the boards are in planes lower rectangular dial. In a second embodiment of the wing between the boards is the profile of polyurethane, which is centrally in the middle on the bottom of selecting the side walls to the top and bottom sections are interconnected comp vertical section located at an acute angle. The post is comprised of four wooden planks glued each other and between which the profile is a polyurethane wherein the support elements are in the form known as sizing, which is boards glued in such a way that the wood grain are adjusted so that the individual layers of mutually withstand the possibility of warping. At the extreme board on the one hand there is in the upper and lower profiled projecting part over the other components, forming the plane of the glass to the package, and symmetrically on the other hand are located glazing, security glass from falling. Glazing bead and fused glass package and are sealed with silicone. In the second embodiment it consists of six wooden planks glued each other.

The frame in which are embedded wings—mobile and passive, is made up of several glued planks centrally located in the middle part 2, extended beyond the plane of the upper frame that separates and seals the wings passive and active.

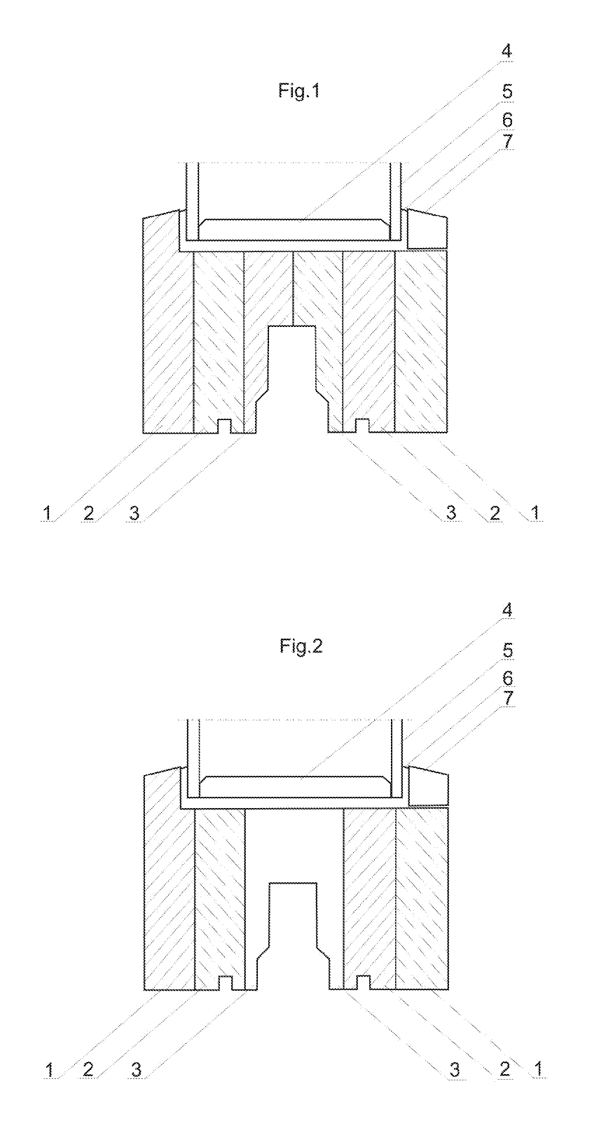

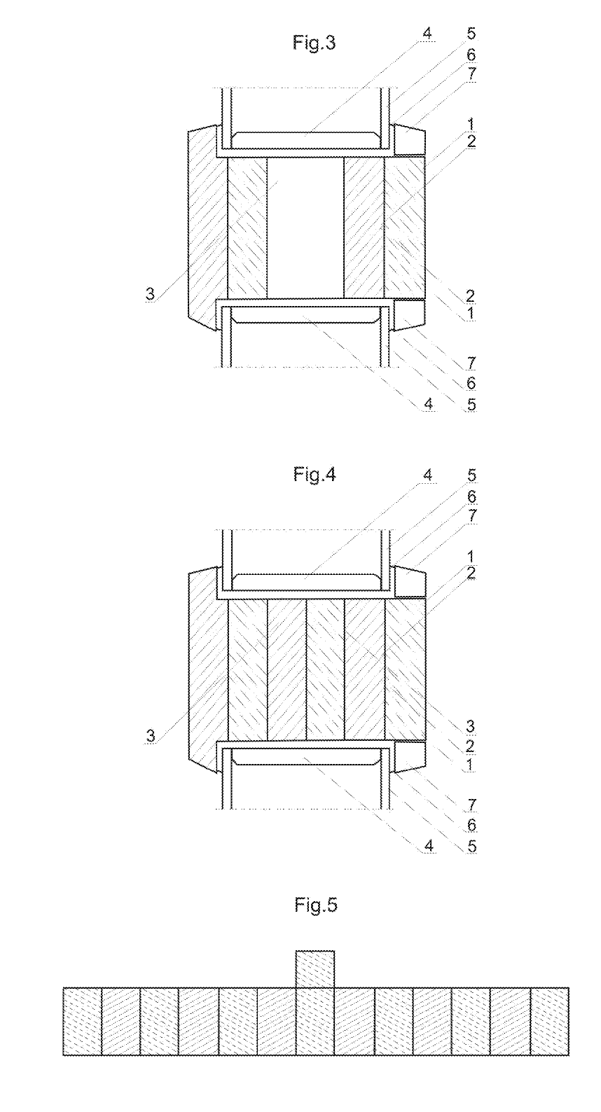

Due to the insulating effects are used sets of wings of FIG. 2 to the post and the wings of FIG. 1 FIG. 3 with FIG. 4 bars.

Frame structure, wings and posts of wood for insulating windows for passive construction according to the invention are shown in the accompanying illustrative material, in which FIG. 1-2 shows a wing cross-sectional, FIG. 3-4 bars in cross-section, and FIG. 5 frame in cross section.

Frame structure, wings and posts according to the invention is shown in more detail in the embodiment.

### EXAMPLE 1

The wing consists of six elements in the form of a rectangular wooden boards 1-3 interconnected preferably with an adhesive, wherein the components are glued in such a way that the wood grain of the respective connected elements are adjusted alternately to provide structural rigidity and eliminating the possibility of warping, with the extreme board 1 is in the upper part of the profile projecting above the other components, forming the plane of the glass package, and symmetrically on the other hand is located glazing bead 7 that protects the glass from falling out. Glazing bead 7 and a package of glass 4.5 complex and sealed with silicon 6. The central board 3 centrally in the middle on the lower part with a recess whose side walls to the top and bottom sections are interconnected comp vertical section located at an acute angle, and the board 2 are in the select a rectangular lower levels. The post consists of six wooden planks glued each other 1-3, wherein the support elements are in the form known as sizing, which is boards glued in such a way that the wood grain are adjusted so that the individual layers of mutually withstand the possibility of warping. At the extreme board 1 on the one hand, is in the upper and lower profiled projecting part over the other components, forming the plane of the glass to the package, and symmetrically on the other hand are located glazing 7, protecting the glass against falling out. Glazing bead 7 and 4.5 combined package of glass and sealed with silicone 6.

### EXAMPLE 2

The wing consists of five elements in the form of four rectangular wooden boards 1,2 are interconnected preferably by means of an adhesive, wherein the components are glued in such a way that the wood grain of the respective connected elements are adjusted alternately to provide structural rigidity and eliminating the possibility of warping. Between the boards is 1.2 profile polyurethane 3, which is centrally in the middle on the bottom of selecting the side walls to the top and bottom sections are interconnected comp vertical section located at an acute angle. Boards 2 are in planes lower rectangular recesses wherein the extreme board 1 is in the upper profiled projecting part over the other components, forming the plane of the package glass, and symmetrically on the other hand is located glazing bead 7 that protects the glass from falling out. Glazing bead 7 and a package of glass 4.5 complex and sealed with silicon 6. The post is comprised of four wooden planks glued 1,2 another, and between which the profile is polyurethane 3, wherein the support elements are in the form known as sizing, which is boards glued in such a way that the wood grain are adjusted so that the individual layers each abolished the possibility of warping, the extreme board 1 on the one hand, is in the upper and lower profiled projecting part over the other elements form a plane support for packages of glass, and symmetrically on the other hand are located glazing 7, protecting the glass against falling out. Glazing bead 7 and 4.5 combined package of glass and sealed with silicone 6.

The frame in which are embedded wings—mobile and passive is made up of several glued boards 1, forming part of a total thickness of approx. 310 mm centrally located in the middle of element 2, projecting beyond the upper face of the frame which are separated and sealed towards the passive and active.

### SUMMARY

The present solution is the structure of frame, wings and posts of wood for the construction of window insulation for building passive, characterized in that consists of six elements in the form of a rectangular wooden boards 1-3 interconnected in such a way that the wood grain of the various connected elements They are adjusted alternately, wherein the extreme board 1 is in the upper part of the profile projecting above the other components, forming the plane of the glass package, and symmetrically on the other hand is located glazing bead 7, the glazing bead 7 and a package of glass 4, 5 complex and sealed with silicon 6, and the central board 3 centrally provided with a recess whose side walls to the top and bottom have comp vertical sections connected section located at an acute angle, and the board 2 are in planes lower rectangular recesses and the bar consists of six wooden boards 1-3 glued each other in such a way that the wood grain of the various connected elements are adjusted alternately, wherein the extreme board 1 on the one hand, is in the upper and lower profiled projecting part over the other components, forming the plane of the packets glass and symmetrically on the other side they are located glazing lath 7 and the frame is made up of several planks glued one centrally located in the middle of element 2, projecting beyond the upper face of the frame.

1. Construction of frames, wings and posts of wood for insulating windows for passive construction, characterized in that the wing consists of six elements in the form of a rectangular wooden boards 1-3 interconnected in such a way that the wood grain of the respective connected elements are matched alternately, the extreme board is in the upper part of the profile projecting above the other components, forming the plane of the glass package, and symmetrically on the other hand is located glazing bead, the glazing bead and a package of glass laminated and sealed with silicon, and the central board centrally provided with a recess whose side walls to the top and bottom sections are interconnected comp vertical section located at an acute angle, and the board are in planes lower rectangular recesses and the bar consists of six wooden planks glued each other in such a way that the wood grain of the various connected elements are adjusted alternately, wherein the extreme board on the one hand is in the upper and lower profiled projecting part over the other components, forming the plane of the packets glass and symmetrically on the other hand they are located glazing and the frame is made up of several planks glued one centrally located in the middle of element, projecting beyond the upper face of the frame.

2. The construction of frames, sashes and bars according to claim 1, characterized in that the wing consists of five elements in the form of four rectangular wooden boards between which is a polyurethane profile and the post is comprised of four wooden planks between which is the profile of polyurethane.
